(19) United States
(12) Patent Application Publication
(10) Pub. No.: US 2003/0016586 A1
(43) Pub. Date: Jan. 23, 2003

(54) Apparatus and methods for securing a container for mixing

(76) Inventor: Steven Williams, Duluth, MN (US)

Correspondence Address: Alan D. Kamrath, Rider, Bennett, Egan & Arundel, LLP, Suite 2000, 333 South Seventh Street, Minneapolis, MN, 55402, US

(21) Appl. No.: 09/907,883

(22) Filed: Jul. 17, 2001

(51) Int. Cl. B01F 15/00

(52) U.S. Cl. 366/349

(57) ABSTRACT

An apparatus (10) and methods for securing a container (70) while mixing viscous material located therein are provided. The apparatus (10) includes a portable holder device (12) and a retention device (14) secured to one another such that apparatus (10) can receive and prevent the rotation of the container (70). The portable holder device (12) includes a platform portion (22) to receive the weight of the user (11) and a container support portion (24) to receive the container (70). In the most preferred form, the portable holder device (12) is in the form of a hexagonal shaped, planar base. The container (70) includes at least one abutment (76) to cooperate with the retention device (14) to prevent rotation of the container (70) during a mixing operation. In the most preferred form, the retention device (14) is in the form of first and second bars (17, 19) having upper ends which are slideably received in slots (66) of container handle hinge assemblies (63). The methods include providing an apparatus (10) having a portable holder device (12) and a retention device (14), placing a container (70) on a container support portion (24) of the portable holder device (12), applying weight of a user (11) to a platform portion (22) of the portable holder device (12), and mixing the contents of the container (70).

### BACKGROUND OF THE INVENTION

1. Field of the Invention

The present invention relates to an apparatus and methods for securing a container and, more particularly, to an apparatus and methods for securing a container for mixing of a viscous material within the container.

2. Description of the Related Art

Pre-mixed plaster is provided by manufacturers in leak-proof containers. Frequently, the containers are plastic buckets. Typically, the buckets are available in three and five gallon (seven and nineteen liter) sizes, although other sizes may be used by manufacturers. After the purchase of pre-mixed plaster materials, remixing is usually required to homogenize the components of the plaster that separate over time before applying the plaster to a surface. On the worksite, the plaster is typically homogenized directly within the containers. This prevents workers from having to transfer the plaster to a separate mixing container and, thereby, reduces the likelihood of spilling the contents of the container. The use of a mixing unit such as a portable drill with a mixing attachment reduces the fatiguing of the worker but does not prevent the rotation of the container during mixing. However, the containers provided by manufacturers are not particularly adapted to facilitate a mixing operation. Specifically, pre-mixed plaster as well as other materials typically mixed on the worksite, such as mortar, grout and concrete are extremely viscous and, therefore, difficult to mix. When a worker attempts to mix the material in the container, the container tends to rotate in the same direction as the mixing unit. The rotation of the container reduces the efficiency of the mixing operation, increasing the time required to mix the components and fatiguing the worker. To prevent the container's movement and rotation, containers historically have been gripped between a user's feet and legs. However, this method of preventing movement and rotation has itself proven fatiguing to the worker's feet and/or legs even when using a portable drill. Further, it is generally difficult to maintain one's position and balance over the container when mixing material in the container with a mixing unit.

The use of one's feet and legs to prevent movement and rotation can also be dangerous. If the container slips and begins to rotate, a worker could be injured and/or the contents of the container could be expelled from the container resulting in additional costs and a difficult clean-up. An injured worker may be unable to work or, if able to work, may be less productive than a healthy worker. An injury may even further result in a lawsuit for worker's compensation further increasing construction costs. Therefore, a need exists for an apparatus and methods to safely secure a container against rotation for a mixing operation.

As an alternative, non-specialized devices such as various clamps, belts or other securing devices, typically found on worksites, may be used to secure a container for mixing. However, the worker must transport the container and clamp or belt to a structure on or near the worksite to which the container can be secured. Then, the user must secure the belt or clamp to the structure and to the container. After mixing, the belt or clamp must be removed from the structure and container, and the container must be transported to a location convenient for its use. This significantly increases the amount of time required to mix the materials. The increase in time increases the costs of the project, and the transport and securing operations can fatigue the workers. Further, the increased number of components required for this mixing operation increases the likelihood that a clamp or belt will fail, delaying the project until a replacement can be provided. Therefore, a need exists for an apparatus and methods permitting a simple and efficient securing of a container to prevent movement during a mixing operation. Further, a need exists for an apparatus and methods for securing a container that is portable around the workplace.

Dedicated mixers for the mixing of plaster, mortar, grout, concrete, and other construction materials provide another alternative to hand mixing. However, dedicated mixers are relatively large, cumbersome, expensive and dangerous to operate. Thus, their purchase, rental or transport is frequently not warranted for many projects, and they do not increase the level of safety on the worksite. Further, their use can require the utilization of trained, more highly paid operators on the worksite. Therefore, a need exists for a safe, simple and portable apparatus and methods that do not require a trained operator for mixing materials on a worksite.

### SUMMARY OF THE INVENTION

The present invention solves the above-listed needs and other deficiencies and problems in the art by providing, in the preferred form, a simple, portable apparatus and methods for securing a container against movement during a mixing operation.

An apparatus in accordance with the present invention includes a portable holder device and a retention device secured to one another such that the apparatus can receive and prevent the rotation of a container. The apparatus prevents the container that can hold a viscous material from rotating relative to a support surface during mixing of the viscous material by a mixing unit within the container. The portable holder device includes a platform portion to receive the weight of the user and a container support portion to receive the container. The portable holder device is generally adapted to be removably supported upon the support surface. The platform portion of the portable holder device is adapted to receive the weight of the user by standing thereon to prevent movement of the portable holder device relative to the support surface. The platform portion can extend around the container support portion to encompass diametrically opposite sides of the container. The platform portion can be, at least in part, positioned behind the container to allow a user to stand pigeon toed with both feet totally on the platform portion during mixing. The container support portion is adapted to receive the weight of the container, the viscous material, and a force applied by the mixing unit during the mixing operation. The container support portion can be adapted to receive the container when moved in a vertical direction and is sandwiched between the container and the support surface. The container support portion can have a flat top surface to abut with the bottom of the container. The retention device can be in the form of one or more bars, rods, tubes, flat plates, curved plates or other forms capable of preventing the rotation of a container. When a first bar and a second bar are provided as the retention device, the first and second bars can be spaced apart by the diameter of the container to allow the first and second bars to be received on diametrically opposite sides of the container. The retention device can be adapted to contact an abutment on the container when the container is received in the container support portion. The retention device thereby prevents rotation of the abutment beyond the retention device, with the portable holder device preventing the container from rotating during mixing of the viscous material within the container.

The container can include at least one abutment to cooperate with the retention device to prevent the rotation of the container during a mixing operation. The container can further include a bottom and a side wall, with the abutment(s) extending radially relative to the center of the container. The abutment may be a part of a hinge assembly connected to and extending from an exterior surface of the side wall of the container.

The methods include providing an apparatus having a portable holder device and a retention device, receiving a container in the container support portion of the portable holder device, applying weight of a user to a platform portion of the portable holder device, and mixing the contents of the container while the container is received in the container support portion and the weight of the user is applied to the platform portion.

It is thus an object of the present invention to provide novel apparatus and methods for securing a container for mixing.

It is further an object of the present invention to provide such novel apparatus and methods which can secure a container in a simple operation.

It is further an object of the present invention to provide such novel apparatus and methods to secure a container for mixing by resting the container on the apparatus.

It is further an object of the present invention to provide such novel apparatus and methods which can secure a container against rotation without the need for specialized training, or additional equipment or tools.

It is further an object of the present invention to provide such novel apparatus and methods which can be portable.

It is further an object of the present invention to provide such novel apparatus which can be lightweight.

It is further an object of the present invention to provide such novel apparatus and methods which can be utilized in confined spaces.

It is further an object of the present invention to provide such novel apparatus and methods which can be simple to construct and does not include small, removable, movable and/or easily lost components.

It is further an object of the present invention to provide such novel apparatus which can be inexpensive to manufacture.

It is further an object of the present invention to provide such novel apparatus and methods utilizing a minimum of parts.

These and other objects, features, and advantages of the present invention will become more readily apparent from the following detailed description of the preferred embodiment of the invention when taken in conjunction with the drawings wherein like reference numerals refer to corresponding parts in the several views.

### BRIEF DESCRIPTION OF THE DRAWINGS

The illustrative embodiment may best be described by reference to the accompanying drawings where:

FIG. 1 illustrates a perspective view of an embodiment of a container securing apparatus in accordance with the present invention;

FIG. 2 illustrates an exploded perspective view of the container securing apparatus, as in FIG. 1, showing the placement of a container between a pair of retention bars; and

FIG. 3 illustrates a partial side-view in cross-section of an embodiment of a container secured over a retention device of the container securing apparatus, as in FIG. 1, according to section line 3-3 of FIG. 1.

All figures are drawn for ease of explanation of the basic teachings of the present invention only; the extensions of the figures with respect to number, position, relationship and dimensions of the parts to form the preferred embodiment will be explained or will be within the skill of the art after the following description has been read and understood. Further, the exact dimensions and dimensional proportions to conform to specific force, weight, strength, and similar requirements will likewise be within the skill of the art after the following description has been read and understood.

Where used in various figures of the drawings, the same numerals designate the same or similar parts. Furthermore, when the terms “top,” “bottom,” “right,” “left,” “forward,” “rear,”“first,” “second,” “inside,” “outside,” and similar terms are used, the terms should be understood to reference only the structure shown in the drawings as it would appear to a person viewing the drawings and utilized only to facilitate describing the illustrated embodiment.

### DETAILED DESCRIPTION OF THE INVENTION

An apparatus for securing a container against movement while utilizing methods according to the preferred teachings of the present invention is shown in the drawings and generally designated 10. In a most preferred form of the present invention, apparatus 10 utilizes a portable holder device 12 adapted to be removably supported upon a support surface and a retention device 14. Container 70 to be secured by apparatus 10 is typically in the form of a bucket having a handle 78. Container 70 generally includes a bottom 72, a side wall 74 and at least one abutment 76. Generally, container 70 is configured to retain a material to be mixed within a cavity defined thereby. Abutment 76 is generally shaped and positioned to cooperate with retention device 14 while container 70 is received in portable holder device 12 to prevent rotation of container 70 during a mixing operation. In a preferred form, abutment 76 can be integral with a hinge assembly 63 for connection of a handle 78 to container 70. Particularly, hinge assembly 63 in the form shown is defined by a hinge flange 64 for attachment of handle 78 to container 70 and by first and second abutments 76 for reinforcing hinge flange 64. Thus, abutments 76 typically cooperate with hinge flange 64 to define two slots 66 on diametrically opposite sides of container 70 for mounting handle 78. These slots 66 of hinge assemblies 63 have a width defined as the distance between abutments 76. Alternatively, abutment 76 may be a portion of handle 78, may be one or more flanges positioned on an outside surface of bottom 72 or side wall 74, or may be an indentation on bottom 72 or side wall 74 of container 70. Regardless of the configuration of abutment 76, abutment 76 cooperates with at least a portion of retention device 14 to prevent rotation of container 70 during a mixing operation. Retention device 14 is generally adapted to prevent the rotation of container 70, and portable device holder 12 is generally adapted to receive at least a portion of a user's weight and to receive and support container 70.

According to the preferred teachings of the present invention, portable holder device 12 includes a platform portion 22 and a container support portion 24. Portable holder device 12 is formed from a material or combination of materials having sufficient strength to withstand the weight of user 11 and materials being mixed, and to withstand the rotational forces conferred to container 70 by a mixing operation. Platform portion 22 is adapted to receive at least a portion of the weight of user 11 on a top surface 16 of platform portion 22. In a preferred form, platform portion 22 is adapted to receive at least a portion of the foot of user 11 so that the user's weight may prevent movement of apparatus 10 relative to the support surface during a mixing operation. In a most preferred form, platform portion 22 is sized and shaped to receive all or substantially all of both feet of user 11. When adapted to receive all or substantially all of the user's feet as in the preferred form, platform portion 22 may be configured relative to container support portion 24 so that a worker 11 mixing material in container 70 is standing with his feet at an oblique angle and his toes approximating diametrically opposite sides of container 70. For exemplary purposes, portable holder device 12 is shown having a hexagonal shape. The hexagonally shaped portable holder device 12 is shown sufficiently sized to provide a platform portion that allows the user 11 to stand pigeon toed, as described above, while mixing the material with a mixing unit shown in the preferred form as a portable drill 13 having a mixing attachment 15. Alternatively, a variety of other shapes and configurations can be used for platform portion 22 and portable holder device 12 to allow user 11 to place a portion or all of one or both feet on portable holder device 12 to confer sufficient force to prevent movement of the apparatus 10 during a mixing operation. A top surface 16 of platform portion 22 may comprise a non-slip surface, such as wire grating or other known non-slip surfaces, to prevent the feet of user 11 from slipping while mixing. Further, when top surface 16 is a wire grating, dirt and other debris from container 70 and user 11 may pass through top surface 16 to the support surface on which apparatus 10 is resting.

Container support portion 24 can be connected to or integral with platform portion 22 so that the weight of user 11 on platform portion 22 prevents substantial movement of container support portion 24 to allow mixing of the contents of container 70. Container support portion 24 is adapted to receive container 70 when moved in a vertical direction, with container support portion 24 being sandwiched between container 70 and the support surface. In a preferred form, container support portion 24 receives at least a portion of bottom 72 of container 70 on a top surface 26 of container support portion 24.

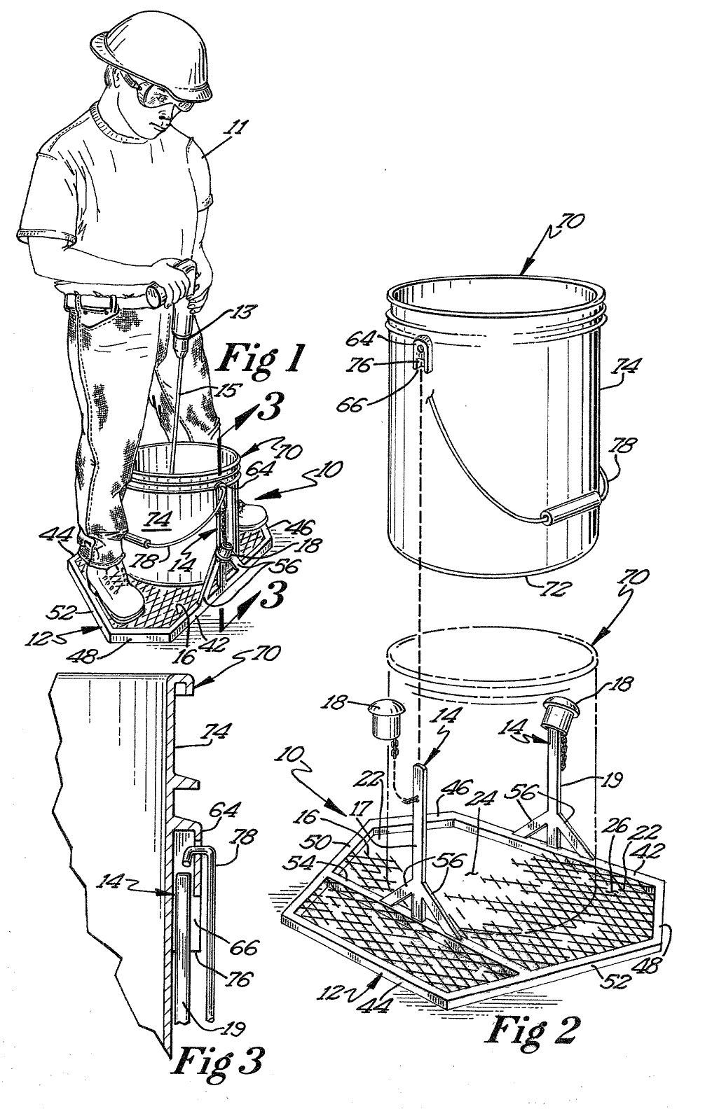

In the most preferred form, container support portion 24 provides top surface 26 to stably support at least a portion of the bottom 72 of container 70 on top surface 26 of container support portion 24. Container support portion 24 is configured to support at least a portion of the weight of container 70. In a most preferred form, container support portion 24 comprises surface 26 which is flat and sized to receive bottom 72 of container 70, as shown in FIGS. 1 and 2. Top surface 26 may comprise a wire grating to allow debris to pass through top surface 26 allowing container 70 to stably rest on top surface 26. In a most preferred form, top surface 26 of container support portion 24 is integral, contiguous, and planar with top surface 16 of platform portion 24.

A bottom surface of portable holder device 12 is generally adapted to support at least a portion of portable holder device 12 on the support surface. The support surface generally being any surface on which the portable holder device 12 is placed. The bottom surface may simply be a flat surface with no additional structure, may include additional structures, or may be otherwise configured to maintain a stable platform during a mixing operation. In one form, the bottom surface includes a plurality of rubber feet configured to prevent portable device holder 12 from slipping during a mixing operation. The portable holder device 12 can also include one or more legs configured to hold the portable device holder 12 stably above the support surface during the mixing operation.

Portable holder device 12 can be a solid piece of material or may be a frame having top surfaces 16 and 26 secured to members of the frame. For exemplary purposes, portable holder device 12 is illustrated, in FIGS. 1 and 2, as a frame formed from a plurality of members. Specifically, as shown in FIGS. 1 and 2, portable holder device 12 includes a front member 42, a rear member 44, a first side member 46, a second side member 48, a third side member 50, a fourth side member 52, and a reinforcing member 54. Members 42, 44, 46, 48, 50, 52, and 54 are secured to one another to form portable holder device 12. Specifically, in the preferred form shown, front member 42, rear member 44, and reinforcing member 54 are in a spaced, parallel relation, with reinforcing member 54 being intermediate front and rear members 42 and 44 and spaced from but member 42 generally equal to the diameter of container 70. Rear member 44 has a length slightly longer than the diameter of container 70 and in the preferred form is generally equal to 120% of the diameter of container 70. Front member 44 has a length greater than rear member 44 and in the preferred form is generally equal to 130% of the length of rear member 44. Third and fourth side members 50 and 52 are of equal length and extend at equal obtuse angles outwardly from the opposite ends of rear member 44. Reinforcing member 54 extends between side members 50 and 52 with a spacing from rear member 44 considerably smaller than the spacing from front member 42 and in the most preferred form generally one half of the spacing from front member 42. First and second side members 46 and 48 are of equal length considerably shorter than the length of members 50 and 52 and extend at equal obtuse angles outwardly from the opposite ends of front member 42. The free ends of side members 46 and 50 and of side members 48 and 52 are interconnected at equal obtuse angles. Members 42, 44, 46, 50, and 52 form the hexagonal shape of the most preferred form. The interconnections of members 46 and 50 and of members 48 and 52 are spaced greater than the spacing between members 42 and 54 and greater than the diameter of container 70, with the interconnections located closer to member 42 than member 54 and in the preferred form is located about 60% of the spacing between members 42 and 54 from member 54. Typically, when formed of metal, members 42, 44, 46, 48, 50, 52, and 54 are secured together by welding. The top surfaces 16 and 26, shown as a wire grating, may be secured to members 42, 44, 46, 48, 50, 52, and 54 by welding. The wire grating provides an exemplary non-slip material for use as top surfaces 16 and 26. Alternatively, a variety of materials having a high coefficient of friction or textured surfaces may be used as the non-slip material. However, it can be appreciated that the preferred portable device 12 shown is advantageous at least because of ease of manufacture through the use of linear components or edges and the lack of accurate edges, because of its planar configuration, because of its lightweight leading toward its portability, and the like.

Retention device 14 is generally adapted to cooperate with abutment 76 on container 70 to prevent the container's rotation. Retention device 14 is typically attached to and extends from portable holder device 12. In a preferred form shown, retention device 14 is in the form of a first bar 17 and a second bar 19 extending upward from top surface 16 of portable holder device 12, with first bar 17 and second bar 19 being spaced generally equal to the diameter of container 70 to slideably receive container 70 between one another. In this form, first bar 17 and second bar 19 may be spaced, as illustrated in FIGS. 1 and 2, so that the bars 17 and 19 are positioned on diametrically opposite sides of container 70 when container 70 is positioned on container support portion 24 or may be otherwise positioned to secure container 70. To prevent rotation of container 70, the ends of first bar 17 and second bar 19 can be shaped to cooperate with one or more abutments 76 on container 70.

In preferred forms, retention device 14 is secured to one of the top surface or a side surface of portable holder device 12, although retention device 14 may be otherwise secured to portable holder device 12 to prevent rotation of container 70. In the embodiment shown in FIG. 2, first bar 17 is shown secured to the top surface of front member 42 and second bar 19 is shown secured to the top surface of reinforcing member 54 for exemplary purposes. Retention device 14 may be welded to the base, integrally molded with the base, secured within slots cut into the base or otherwise be attached to the base as will be recognized by those skilled in the art. In addition, one or more retention device support braces 56 extending between bars 17 and 19 and members 42 and 54, respectively, can also be provided to further support and/or strengthen retention bars 17 and 19.

When in a form that may pose a danger to a falling worker, retention device 14 can be provided with a safety cap 18. Safety cap 18 can be slidably secured over the retention device 14 or otherwise removably secured to retention device 14 to prevent an individual from being impaled on retention device 14. First and second safety caps 18 are shown attached to bars 17 and 19 of the preferred form with a chain for exemplary purposes so that safety caps 18 are not separated from apparatus 10 and lost.

The particular manner in which abutment 76 and retention device 14 cooperate varies. As illustrated in FIGS. 1 to 3, a preferred form of retention device 14 in the form of first bar 17 and second bar 19 adapted to receive container 70 therebetween prevents rotation of container 70. Either or both of first bar 17 and second bar 19 may then contact abutment 76 to prevent rotation. In the preferred form, each of first bar 17 and second bar 19 are received in slots 66 and between two abutments 76 of hinge assembly 63. The width between abutments 76 is generally equal to but slight greater than the width of first bar 17 and second bar 19 to allow first bar 17 and second bar 19 to be slideably received in slots 66 and between abutments 76. Specifically, in this most preferred embodiment, first bar 17 and second bar 19 cooperate with abutments 76 to allow container 70 to be secured for mixing by lowering container 70 vertically between first bar 17 and second bar 19 onto container support portion 24, as illustrated in FIG. 2. During mixing, when two abutments 76 are parallel to form slot 66, one abutment 76 of each slot 66 typically prevents the rotation of container 70 depending on the direction of rotation of mixing attachment 15 within container 70 because of the rotational forces tending to rotate container 70 in the direction of the mixing.

FIGS. 1 and 2 further illustrate an exemplary placement of a container 70 onto an embodiment of a apparatus 10. Specifically, container 70 is positioned vertically above apparatus 10 and with bars 17 and 19 located on diametrically opposite sides of container 70. Container 70 is then rotated about its axial center until abutments 76 are located vertically above retention device 14 to align slots 66 with bars 17 and 19 in the most preferred form, if container 70 was not so aligned. Again, apparatus 10 is typically configured to allow a container to be secured for mixing by simply placing the container on container support portion 24. Container 70 is vertically lowered into apparatus 10 so that first bar 17 and second bar 19 can be inserted into slots 66 between abutments 76. Container 70 is lowered in the preferred form until bottom 72 engages with and is supported upon top surface 26 of container support portion 24. In the preferred form, the top ends of bars 17 and 19 do not engage with hinge assembly 63 in a manner to receive the weight of container 70 in a vertical direction.

After container 70 is placed in apparatus 10 such that bottom 72 of container 70 is resting on container support portion 24 in the preferred form and at least one abutment 76 abuts retention device 14, user 11 places at least a portion of the user's weight on platform portion 22 of portable holder device 12. Particularly, user 11 can apply his weight by placing at least a portion of the user's foot onto platform portion 22. In the most preferred form, user 11 places both feet upon the platform portion 22 and particularly pigeon toed thereon with the user's toes being on diametrically opposite sides of container 70 and at 90° from bars 17 and 19 and with the heels extending on top surface 26 between reinforcing member 54 and rear member 44 and at reduced spacing than the toes. User 11 then mixes the material within container 70. For exemplary purposes, user 1 1 is shown mixing the material with portable drill 13 with attached mixing attachment 15. Once mixing is completed, container 70 may be removed, typically by handle 78, by simply raising container 70 in a vertical direction from apparatus 10 while weight is placed on platform portion 22 such as being stepped on by user 11. After container 70 has been removed from apparatus 10, a set of safety caps 18 may be slideably received over the ends of first bar 17 and second bar 19 to reduce the risk of impingent by bars 17 and 19 if accidentally engaged by user 11.

It should be appreciated that apparatus 10 is advantageous as container 70 can be received in and removed from apparatus 10 by simple vertical movement of container 70 relative to apparatus 10 and specifically without requiring clamping, buckling, or similar attachment. Slideable receipt as in the preferred form of the present invention avoids the time and effort required for attachment steps and avoids the need for movable components which increase the component cost and assembly and which are subject to wear and breakage.

Now that the basic teachings of the present invention have been explained, many extensions and variations will be obvious to one having ordinary skill in the art. For example, the ends of first bar 17 and second bar 19 are shown as perpendicular to the underlying surface for receipt in slot 66 in the most preferred form for exemplary reasons only. The ends of first bar 17 and second bar 19 may be positioned at an alternative angle to abut with abutments 76, as will be recognized by those skilled in the art, to further secure container 70 to apparatus 10 when a torque is applied during mixing.

Likewise, although abutment 76 is shown as part of hinge assembly 63 in the most preferred form, abutment 76 can take other forms as previously indicated, and retention device 14 can be modified according to the teachings of the present invention to mate with the particular type of abutment 76 on container 70. As an example, a portion of handle 78 may function as abutment 76 of container 70. Typically, the portion of handle 78 preventing rotation is the portion extending through hinge flange 64 into slot 66. In this embodiment, retention device 14 contacts the portion of handle 78, functioning as abutment 76, to prevent the rotation of container 70. In yet another form, abutment 76 may be a portion of a depression in side wall 74 or bottom 76 of container 70. In this form, retention device 14 could be received within the depression to contact abutment 76 during mixing so as to prevent rotation of container 70. As is evident upon review of the disclosure, abutment 76 need not be adjacent a hinge flange 64 nor does the abutment 76 need to define slot 66 to prevent rotation. Abutments 76 are shown adjacent hinge flange 64 and forming slot 66 for exemplary purposes only. One or more abutments 76 can be provided at any location on container 70 to contact abutment 76 when container 70 is received in container support portion 24 such as when bottom 72 of container 70 is in contact with top surface 26 of portable holder 12 in the preferred form and, thus, prevent rotation of container 70 during mixing.

Similarly, although retention device 14 in its most preferred form is shown in the form of first and second bars 17 and 19 where their ends are received in slots 66 and have vertically extending side edges which abut against first and second abutments 76, retention devices 14 can take other forms according to the teachings of the present invention which mate with one or more abutments 76 in a male or female manner. Specifically, retention device 14 may be configured as one or more rods, tubes, curved plates, or flat plates, or may be otherwise configured to mate with one or more abutments 76 to prevent the rotation of container 70 received in container support portion 24.

Likewise, although retention device 14 in the preferred form is nonadjustable and fixed to accept a particular size and shape of a typical container 70 for holding plaster, retention devices 14 can be formed according to the teachings of the present invention to be adjustable to receive containers 70 of differing heights, diametric sizes, or shapes. As an example, retention device 14 in the forms of bars 17 and 19 could be adjustable in height by being a two piece construction removably interconnected together, if desired or necessary.

Furthermore, although container support portion 24 in the most preferred form receives container 70 by abutment with bottom 72 of container 70, container support portion 24 can be other forms according to the teachings of the present invention which is adapted to receive the weight of container 70, the material held in container 70 and the force applied by a mixing unit such as portable drill 13 and attachment 15. In this regard, container support portion 24 could be formed to abut with portions of container 70 other than or in addition to bottom 72. However, it can be appreciated that the abutment with bottom 72 of container 70 is particularly advantageous in allowing container support portion 24 and platform portion 22 to be formed as a single planar component.

Thus, since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. Apparatus for preventing a container holding viscous material from rotating relative to a support surface during mixing of the viscous material in the container by a mixing unit held by a user, with the container including a bottom, a side wall, and at least a first abutment extending radially relative to an axial center of the container, comprising, in combination: a portable holder device adapted to be removably supported upon the support surface, with the portable holder device including a platform portion adapted to receive the weight of the user by standing thereon which prevents movement of the portable holder device relative to the support surface, with the portable holder device further including a container support portion adapted to receive the weight of the container, the viscous material held in the container, and a force applied by the mixing unit, with the container support portion adapted to receive the container when moved in a vertical direction and being sandwiched between the container and the support surface; and a retention device secured to the portable holder device, with the retention device adapted to contact the abutment on the container when the container is received in the container support portion to prevent rotation of the abutment beyond the retention device, with the portable holder device preventing the container from rotating during mixing of the viscous material.

2. An apparatus, as in claim 1, with the platform portion being of a size adapted to receive and abut with the bottom of the container, and with the platform portion extending between diametrically opposite portions of the side wall of the container when the container is received in the container support portion.

3. An apparatus, as in claim 1, wherein the retention device is a bar extending vertically relative to the support surface and having a vertically extending portion for abutting with the abutment when the container is received in the container support portion.

4. An apparatus, as in claim 1, with the platform portion positioned, at least in part, radially outward of the side wall of the container received in the container support portion and being of a size to allow the user to stand pigeon toed on the platform portion with toes of feet of the user generally located on diametrically opposite sides of the container and heels of the feet of the user located at reduced spacing than the toes.

5. An apparatus, as in claim 1, with the retention device having a width, with the container further comprising a hinge assembly having a slot defined by a hinge flange and the first abutment and a second abutment, with the first and second abutments being spaced and configured to support the hinge flange, with the width of the retention device being generally equal to the spacing of the first and second abutments and for slideable receipt between the abutments.

6. An apparatus, as in claim 1, with the retention device comprising, in combination: a first bar and a second bar, with the first bar and the second bar spaced generally equal to a diameter of the container to slideably receive the container therebetween.

7. An apparatus, as in claim 1, with the container support portion comprising a flat top surface for abutting with the bottom of the container when the container is received in the container support portion.

8. An apparatus for securing a container during a mixing operation, comprising, in combination:
a portable holder device, comprising a platform portion and a container support portion, with the container support portion adapted to support at least a portion of the container and the platform portion adapted to receive at least a portion of the weight of a user; and
a retention device, with the retention device extending from the portable holder device and adapted to contact an abutment on the container to prevent rotation of the container in at least one direction during a mixing operation of material located in the container supported by the container support portion.

9. An apparatus, as in claim 8, with the retention device comprising, in combination: a first bar and a second bar adapted to slideably receive the container therebetween and to contact the abutment to prevent rotation of the container in at least one direction during a mixing operation of material located in the container supported by the container support portion.

10. An apparatus, as in claim 8, with the retention device having a nonadjustable, fixed height relative to a top surface of the platform portion.

11. An apparatus, as in claim 8, further comprising, in combination: at least one support brace secured between the retention device and the portable holder device to further support the retention device.

12. An apparatus, as in claim 8, with the platform portion being of a size adapted to allow a user to stand with both feet on the platform portion to prevent rotation of the container support portion during a mixing operation.

13. An apparatus, as in claim 8, with the portable holder device having a hexagonal shape.

14. An apparatus, as in claim 13, with the portable device comprising, in combination: a front member; a rear member extending in a spaced parallel relation to the first member; first and second side members extending at equal obtuse angles outwardly from the front member; third and fourth side members extending at equal obtuse angles outwardly from the rear member, with free ends of the first and third side members and of the second and fourth side members being interconnected; and a reinforcing member extending in a spaced parallel relation to the front and rear members, with the reinforcing member being spaced from the front member generally equal to a diameter of the container.

15. An apparatus, as in claim 14, with the retention device comprising, in combination: a first bar secured to the front member intermediate the first and second side members; a second bar secured to the reinforcing member intermediate the third and fourth side members, with the first and second bars extending in a parallel relation spaced generally equal to the diameter of the container and adapted to slideably receive the container therebetween and to contact the abutment to prevent rotation of the container in at least one direction during a mixing operation of material located in the container supported by the container support portion.

16. An apparatus, as in claim 8, with a top surface of the platform portion comprising a non-slip surface.

17. An apparatus, as in claim 16, with the non-slip surface comprising a wire grating.

18. An apparatus, as in claim 8, further comprising, in combination: at least one safety cap removably secured over an end of the retention device.

19. An apparatus for securing a container during a mixing operation of material contained in the container, comprising, in combination:
a means for receiving weight of a user;
a means for receiving the container secured to the means for receiving the weight of the user; and
a means for securing the container secured to at least one of the means for receiving the container and the means for receiving the weight of the user to prevent rotation of the container during the mixing operation of the material contained in the container.

20. A method for mixing a viscous material contained in a container, comprising:
securing the container to an apparatus comprising a portable holder device, with the portable holder device comprising a platform portion and a container support portion, with the container support portion adapted to support at least a portion of the container and the platform portion adapted to receive at least a portion of the weight of a user, with the apparatus further comprising a retention device, with the retention device extending from the portable holder device and adapted to contact an abutment on the container to prevent rotation of the container in at least one direction during a mixing operation; and
mixing the viscous material contained in the container.
